(19) United States
(12) Patent Application Publication
(10) Pub. No.: US 2026/0352559 A1
(43) Pub. Date: Nov. 5, 2026

(54) METHODS, DEVICES AND MEDIUM FOR COMMUNICATION

(71) Applicant: NEC Corporation, Tokyo (JP)

(72) Inventors: Peng GUAN, Beijing (CN); Gang WANG, Beijing (CN)

(73) Assignee: NEC Corporation, Tokyo (JP)

(21) Appl. No.: 19/119,476

(22) PCT Filed: Nov. 11, 2022
(86) PCT No.: PCT/CN2022/131471

§ 371 Date: Apr. 9, 2025

(51) Int. Cl. H04L 41/16; H04L 41/14

(52) U.S. Cl. CPC H04L 41/16; H04L 41/145

(57) ABSTRACT

Embodiments of the present disclosure provide a solution for AI/ML model. A first entity determines at least one of: a first decision or a first action related to an artificial intelligence/machine learning (AI/ML) model management, if a failure of a first AI/ML model occurs. The first decision and/or the first action is determined based on: first information related to a cause of the failure of the first AI/ML model and second information related to a status of a second AI/ML model. In this way, a proper action may be chosen to deal with the failure. Moreover, it can also fast recover the gain of AI/ML operation.

### FIELDS

Example embodiments of the present disclosure generally relate to the field of communication techniques and in particular, to methods, devices, and medium for applying artificial intelligent/machine learning (AI/ML) model for air-interface.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances. Therefore, how to ensure accuracy of output of the AI/ML model is worth studying, in order to ensure satisfying communication performances.

### SUMMARY

In general, embodiments of the present disclosure provide methods, devices and computer storage medium for applying AI/ML model for air-interface.

In a first aspect, there is provided a communication method. The method comprises: determining, at a first entity, at least one of: a first decision or a first action related to an artificial intelligence/machine learning (AI/ML) model management, in accordance with a determination of a failure of a first AI/ML model, and wherein at least one of the first decision or the first action is determined based on: first information related to a cause of the failure of the first AI/ML model and second information related to a status of a second AI/ML model.

In a second aspect, there is provided a communication method. The method comprises: determining, at a second entity, a model monitoring method for a first AI/ML model; monitoring the first AI/ML model based on the model monitoring method; and in accordance with a determination of a failure of the first AI/ML model transmitting one of the followings to a first device: first information related to a cause of the failure of the first AI/ML model, or fourth information about a model monitoring method for the first AI/ML model.

In a third aspect, there is provided a communication device. The communication device comprises at least one processor; and at least one memory coupled to the at least one processor and storing instructions thereon, the instructions, when executed by the at least one processor, causing the communication device to perform the method according to the first aspect.

In a fourth aspect, there is provided a communication device. The communication device comprises at least one processor; and at least one memory coupled to the at least one processor and storing instructions thereon, the instructions, when executed by the at least one processor, causing the communication device to perform the method according to the second aspect.

In a fifth aspect, there is provided a computer readable medium having instructions stored thereon, the instructions, when executed on at least one processor, causing the at least one processor to carry out the method according to the first, or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates a framework of AI/ML model according to some solutions;

FIG. 2 illustrates an example communication environment in which example embodiments of the present disclosure can be implemented;

FIG. 3 shows a schematic diagram of entities associated with AI/ML models;

FIG. 4 illustrates a signaling flow of AI/ML management in accordance with some embodiments of the present disclosure;

FIG. 5 shows an example of status of the second AI/ML model and corresponding actions;

FIG. 6A and FIG. 6B illustrate schematic diagrams of a method where the plurality of first actions are taken, respectively;

FIG. 7 illustrates a flowchart of a method implemented at a first entity according to some example embodiments of the present disclosure;

FIG. 8 illustrates a flowchart of a method implemented at a second entity according to some example embodiments of the present disclosure; and

FIG. 9 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function and can be used to predict some information.

The terminal or the network device may work on several frequency ranges, e.g., FR1

(e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

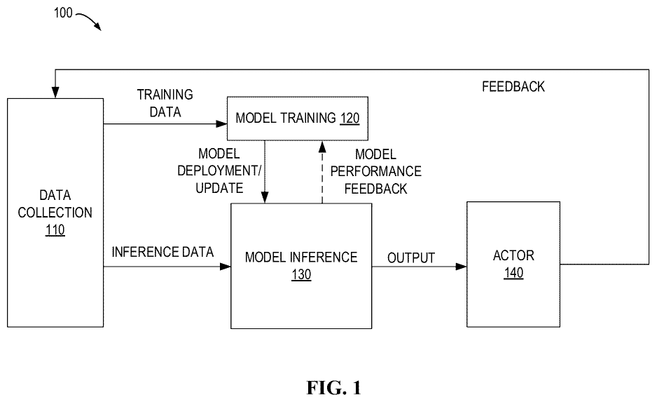

As mentioned above, the AI/ML technology has been proposed. FIG. 1 shows a schematic diagram of an AL/ML framework 100. As shown in FIG. 1, the AI/ML framework 100 may include a data collection module 110, a model training module 120, a model inference model 130, and an actor 140. The data collection module 110 may implement a function that provides input data to Model training and Model inference modules. AI/ML algorithm specific data preparation (e.g., data pre-processing and cleaning, formatting, and transformation) is not carried out in the data collection module 110. Examples of input data may include measurements from UE or different network entities, feedback from Actor, output from an AI/ML model. The training data may refer to data needed as input for the AI/ML Model training module 120. The inference data may refer to data input for the AI/ML Model inference module 130.

The model training module 120 may implement a function that performs the AI/ML model training, validation, and testing which may generate model performance metrics as part of the model testing procedure. The Model Training module is also responsible for data preparation (e.g., data pre-processing and cleaning, formatting, and transformation) based on Training Data delivered by a Data Collection function, if required. Model Deployment/Update may be used to initially deploy a trained, validated, and tested AI/ML model to the model inference module 130 or to deliver an updated model to the model inference module 130.

The model inference module 130 may implement a function that provides AI/ML model inference output (e.g., predictions or decisions). The model inference model 130 may provide a model performance feedback to the model training module 120 when applicable. The model inference module 130 is also responsible for data preparation (e.g., data pre-processing and cleaning, formatting, and transformation) based on inference data delivered by the data collection module 110, if required. An output of the model inference module 130 may refer to an inference output of the AI/ML model produced by a Model Inference function. The model performance feedback may be used for monitoring the performance of the AI/ML model, when available.

The actor 140 may implement a function that receives the output from the model inference module 130 and triggers or performs corresponding actions. The actor 140 may trigger actions directed to other entities or to itself.

Moreover, the AI/ML model can be applied to different scenarios to achieve better performances. For example, the terminal devices can perform the beam management on the AI/ML model. In this case, the terminal device can measure a part of candidate beam pairs and use AI or ML to estimate qualities for all candidate beam pairs. Additionally, the terminal device can perform CSI feedback based on the AI/ML model. In this situation, the original CSI information can be compressed by an AI encoder located in the terminal device and recovered by an AI decoder located in the network device. The AI/ML model can also be used for reference signal (RS) overhead reduction. For example, the terminal device can use a new RS pattern, such as, lower density DMRS, less CSI-RS port. Life cycle management (LCM) is one of core parts for AI/ML related studies. Within LCM, model monitoring is a procedure that monitors the inference performance of the AI/ML model.

In some situations, more than one factor may cause a model failure. Thus, different actions may be needed based on the factor. However, this is no related signaling and model monitoring may be just based on implementations. Additionally, in some situations, an AI/ML model to be switched to may have different status and cannot be applied readily. In this case, different actions may also be needed.

In order to solve at least part of the above problems, embodiments of the present disclosure provide a solution for AI/ML model. A first entity determines at least one of: a first decision or a first action related to an artificial intelligence/machine learning (AI/ML) model management, if a failure of a first AI/ML model occurs. The first decision and/or the first action is determined based on: first information related to a cause of the failure of the first AI/ML model and second information related to a status of a second AI/ML model. In other words, information about why the performance of one AI/ML model is not good and information about what is the status of the to-be-used AI/ML model can be exchanged between entities. In this case, corresponding actions based on the exchanged information can be taken address the address the AI/ML model failure. In this way, a proper action may be chosen to deal with the failure. Moreover, it can also fast recover the gain of AI/ML operation.

In the context of the presented application, the term “AI/ML model” may be interchangeably with the term “model.” The terms “AI/ML model failure”, “model failure”, “failure” and “wrong inference” may be used interchangeably. The terms “AI/ML model success”, “model success”, “success” and “correct inference” may be used interchangeably.

In the context of the presented application, the term “data collection” may refer to a process of collecting data by the network nodes, management entity, or UE for the purpose of AI/ML model training, data analytics and inference. The term “AI/ML model” used herein may refer to a data driven algorithm that applies AI/ML techniques to generate a set of outputs based on a set of inputs. The term “AI/ML model training” used herein may refer to a process to train an AI/ML Model [by learning the input/output relationship] in a data driven manner and obtain the trained AI/ML Model for inference. The term “AI/ML model inference” used herein can refer to a process of using a trained AI/ML model to produce a set of outputs based on a set of inputs.

The term “AI/ML model validation” used herein may refer to a subprocess of training, to evaluate the quality of an AI/ML model using a dataset different from one used for model training, that helps selecting model parameters that generalize beyond the dataset used for model training. The term “AI/ML model testing” used herein may refer to a subprocess of training, to evaluate the performance of a final AI/ML model using a dataset different from one used for model training and validation. Differently from AI/ML model validation, testing does not assume subsequent tuning of the model.

The term “UE-side (AI/ML) model” used herein may refer to an AI/ML Model of which inference is performed entirely at the UE. The term “network-side (AI/ML) model” used herein may refer to an AI/ML Model of which inference is performed entirely at the network. The term “one-side (AI/ML) model” used herein may refer to a UE-side (AI/ML) model or a network-side (AI/ML) model. The term “two Two-sided (AI/ML) model” used herein may refer to a paired AI/ML Model(s) over which joint inference is performed, where joint inference comprises AI/ML Inference whose inference is performed jointly across the UE and the network, i.e, the first part of inference is firstly performed by UE and then the remaining part is performed by gNB, or vice versa.

The term “AI/ML model transfer” used herein may refer to a delivery of an AI/ML model over the air interface, either parameters of a model structure known at the receiving end or a new model with parameters. Delivery may contain a full model or a partial model. The term “model download” used herein may refer to model transfer from the network to UE. The term “model upload” used herein may refer to model transfer from UE to the network. The term “federated learning/federated training” used herein may refer to a machine learning technique that trains an AI/ML model across multiple decentralized edge nodes (e.g., UEs, gNBs) each performing local model training using local data samples. The technique requires multiple interactions of the model, but no exchange of local data samples.

The term “offline field data” used herein may refer to the data collected from field and used for offline training of the AI/ML model. The term “online field data” used herein may refer to the data collected from field and used for online training of the AI/ML model. The term “model monitoring” used herein may refer to a procedure that monitors the inference performance of the AI/ML model.

The term “supervised learning” used herein may refer to a process of training a model from input and its corresponding labels. The term “unsupervised learning” used herein may refer to a process of training a model without labelled data. The term “semi-supervised learning” used herein may refer to a process of training a model with a mix of labelled data and unlabelled data. The term “reinforcement Learning (RL)” used herein may refer to a process of training an AI/ML model from input (a.k.a. state) and a feedback signal (a.k.a. reward) resulting from the model's output (a.k.a. action) in an environment the model is interacting with.

The term “model activation” used herein may refer to enabling an AI/ML model for a specific function. The term “model deactivation” used herein may refer to disabling an AI/ML model for a specific function. The term “model switching” used herein may refer to deactivating a currently active AI/ML model and activating a different AI/ML model for a specific function.

The term “model failure” used herein may refer to a negative outcome of model monitoring. The term “model failure instance” used herein may refer to one wrong inference. The term “model failure instance indication” used herein may refer to an indication of model failure instance from lower layer to higher layer.

The term “model success” used herein may refer to a positive outcome of model monitoring. The term “model success instance” used herein may refer to one correct inference. The term “model recovery” used herein may refer to in response of model failure, achieving model success again. The term “model management” used herein may refer to a more general term includes one or more of following functions/procedures: model activation, deactivation, selection, switching, fallback, and update (including re-training). The term “model registration” used herein may refer to a process of informing the existence of an AI/ML model to the network or to the UE with an identification, along with model description information of the AI/ML model for the network to enable LCM. Model description information may include model format, model functionality, model applicability scenarios, configurations, information on model input, information on model output, information on assistance information, and so on. Model identification may include model type, use case, vendor ID and version number, and so on.

The term “entity” used herein may refer to a device (for example, network device or terminal device). Different functions may be located on the same device, or different procedures may be carried out on the same device. The term “entity” used herein may refer to a model, a block or a logical component that is responsible for specific function/procedure.

Principles and implementations of the present disclosure will be described in detail below with reference to the figures.

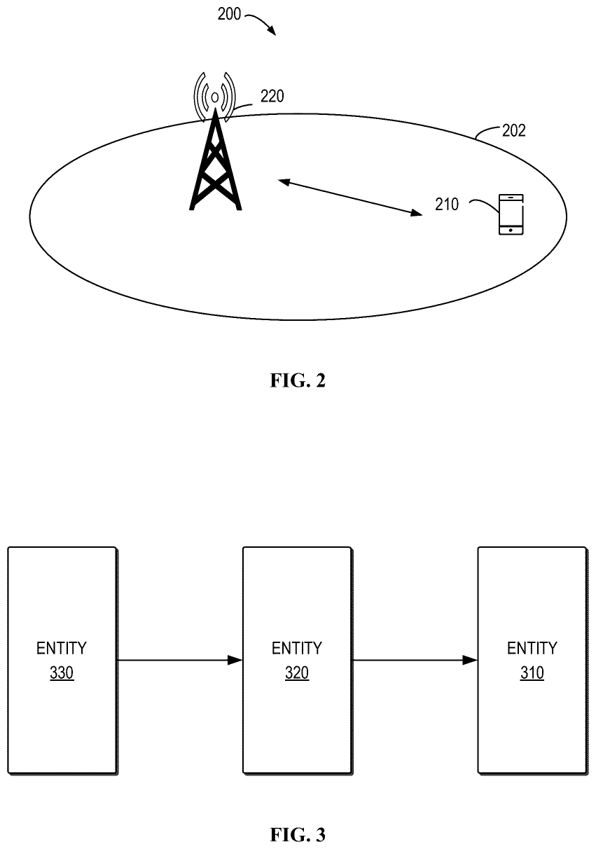

FIG. 2 illustrates a schematic diagram of an example communication environment 200 in which example embodiments of the present disclosure can be implemented. In the communication environment 200, a plurality of communication devices, including a terminal device 210 and a network device 220, can communicate with each other.

In the example of FIG. 2, the terminal device 210 may be a UE and the network device 220 may be a base station serving the UE. The serving area of the network device 220 may be called a cell 202.

It is to be understood that the number of devices and their connections shown in FIG. 2 are only for the purpose of illustration without suggesting any limitation. The communication environment 200 may include any suitable number of devices configured to implementing example embodiments of the present disclosure. Although not shown, it would be appreciated that one or more additional devices may be located in the cell 202, and one or more additional cells may be deployed in the communication environment 200. It is noted that although illustrated as a network device, the network device 220 may be another device than a network device. Although illustrated as a terminal device, the terminal device 210 may be other device than a terminal device.

In the following, for the purpose of illustration, some example embodiments are described with the terminal device 210 operating as a UE and the network device 220 operating as a base station. However, in some example embodiments, operations described in connection with a terminal device may be implemented at a network device or other device, and operations described in connection with a network device may be implemented at a terminal device or other device.

In some example embodiments, a link from the network device 220 to the terminal device 210 is referred to as a downlink (DL), while a link from the terminal device 210 to the network device 220 is referred to as an uplink (UL). In DL, the network device 220 is a transmitting (TX) device (or a transmitter) and the terminal device 210 is a receiving (RX) device (or a receiver). In UL, the terminal device 210 is a TX device (or a transmitter) and the network device 220 is a RX device (or a receiver).

The communications in the communication environment 200 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

FIG. 3 shows a schematic diagram 300 of entities associated with AI/ML models. Information can be exchanged among an entity 310, an entity 320 and an entity 330. In some embodiments, the entity 310 may be responsible for taking action other than model inference based on the performance model monitoring results. For example, the entity 310 may be responsible for actions in response to the AI/ML model failure. In some embodiments, the entity 310 may be responsible for model inference. Alternatively, or in addition, the entity 310 may be responsible for one or more of: for data collection, model training, measurements, configurations, model management. In some embodiments, the entity 310 may be responsible for one or more of: collecting model monitoring results, and/or, for making decision based on model monitoring results.

In some embodiments, the entity 320 may be responsible for model monitoring. Alternatively, or in addition, the entity 320 may be responsible for making decision based on model monitoring results and providing the decision/results to other entity.

In some embodiments, the entity 330 may be responsible for model inference. Alternatively, or in addition, the entity 330 may be responsible for at least one of: data collection, model training, measurements, configurations, or model management. In some other embodiments, the entity 330 may be responsible for collecting model monitoring results, and/or, for making decision based on model monitoring results.

In some embodiments, the entity 310 may be implemented on a terminal device or may be the terminal device, for example the terminal device 210 shown in FIG. 2. In some other embodiments, the entity 310 may be implemented on a network device or may be the network device, for example the network device 220 shown in FIG. 2. The entity 320 may be implemented on the terminal device or may be the terminal device, for example the terminal device 210 shown in FIG. 2. Alternatively, the entity 320 may be implemented on a network device or may be the network device, for example the network device 220 shown in FIG. 2. In some embodiments, the entity 330 may be implemented on the terminal device or may be the terminal device, for example the terminal device 210 shown in FIG. 2. Alternatively, the entity 330 may be implemented on a network device or may be the network device, for example the network device 220 shown in FIG. 2. In some other embodiments, one or more of the entity 310, the entity 320 or the entity 330 may be implemented on a third party device. For example, the third part device may refer to a server performing AI/ML operation or providing AI/ML capability to network nodes including NW device and terminal device. Alternatively, the third party device may refer to a location server in AI/ML for positioning use case.

In some embodiments, the entity 310, the entity 320 and the entity 330 may be located on different devices. Alternatively, the entity 310, the entity 320 and the entity 330 may be located on a same device. FIG. 3 may also include other entity which is omitted for clarity purpose.

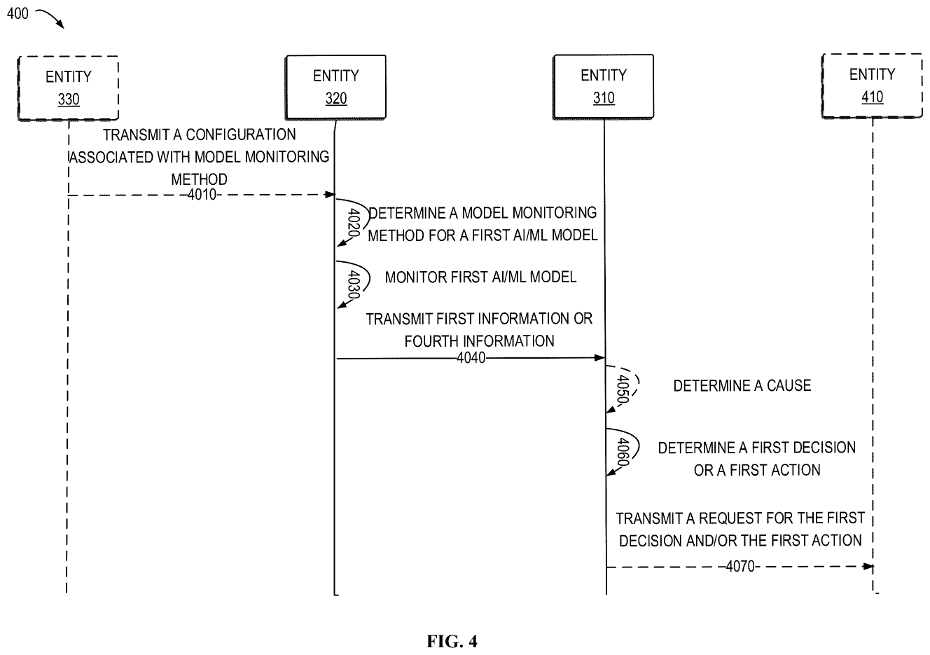

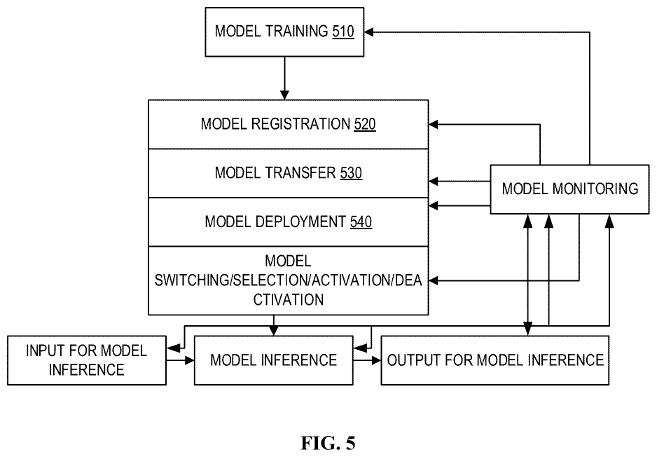

Reference is made to FIG. 4, which illustrates a signaling flow 400 of applying the AI/ML model in accordance with some embodiments of the present disclosure. For the purposes of discussion, the signaling flow 400 will be discussed with reference to FIG. 3, for example, by using the entity 310, the entity 320, the entity 330. It is noted that signaling flow 400 is only an example not limitation. The operations shown in FIG. 4 may take place in different order.

The entity 310 determines (4020) a model monitoring method for a first AI/ML model. In some embodiments, the first AI/ML model may be implemented on the terminal device 110. Alternatively, the first AI/ML model may be implemented on the network device 120. In other embodiments, the first AI/ML model may be implemented on the third-party device.

In some embodiments, the entity 330 may transmit (4010) a configuration associated with the model monitoring method to the entity 320. In this case, the entity 320 may determine the model monitoring method based on the configuration. In this way, it can align model monitor method(s) at least at the entity of model inference and the entity of model monitoring. Moreover, it can avoid complexity for exhaustively monitoring via too many methods.

The need of signaling to configure the model monitoring may be based on at least one of the following: different AI/ML model structure, whether the monitoring entity is the same as the inference entity, or NW-UE collaboration level and the like. For example, if the model inference and model monitoring are performed at the same device, the information/configuration related to the model monitoring method may be exchanged between different entities without signaling.

In some embodiments, assistance information may be needed. For example, if the entity 320 and the entity 330 are at the network device 220 which means that the network device 220 performs both model inference and model monitoring, the network device 220 may require the terminal device 210 to provide measurement results to the network device 220. Alternatively, if the entity 320 and the entity 330 are at the terminal device 210 which means that the terminal device 210 performs both model inference and model monitoring, the terminal device 210 may require the network device 220 to provide measurement resources to the terminal device 210.

In some embodiments, if the entity 320 is at the terminal device 210 and the entity 330 is at the network device 220, the information/configuration related to the model monitoring method may be transmitted via one of: a radio resource control (RRC) configuration, a medium access control (MAC) control element (CE), or downlink control information (DCI). Alternatively, if the entity 320 is at the network device 220 and the entity 330 is at the terminal device 210, the information/configuration related to the model monitoring method may be transmitted via one of: RRC signaling, MAC CE or uplink control information (UCI). In some other embodiments, if one of the entities 320 and 330 is a third party device, the information/configuration related to the model monitoring method may be transmitted via a 3GPP singling or not via a 3GPP signaling. Table 1 below shows an example of signaling exchanges related to the information/configuration related to the model monitoring method.

TABLE 1

| | Entity 320 that is | Signaling of the |
|---|---|---|
| | responsible for | information/configuration |
| | monitoring the first | related to the model |
| | AI/ML model | monitoring method |
| The first AI/ML | The entity 320 is at the | No signaling |
| model is at the | network device 220. | |
| network device 220, | The entity 320 is at the | Indication to the terminal |
| assuming the entity | terminal device 210. | device 210 |
| 330 is at the | The entity 320 is at the | Provide to the third party |
| network device 220. | third party device. | device |
| The first AI/ML | The entity 320 is at the | Feedback to the network |
| model is at the | network device 220. | device 220 |
| terminal device 210, | The entity 320 is at the | No signaling |
| assuming the entity | terminal device 210. | |
| 330 is at the | The entity 320 is at the | Provide to the third party |
| terminal device 210. | third party device. | device |
| The first AI/ML | The entity 320 is at the | Provide to the network |
| model is at the third | network device 220. | device 220 |
| party device, | The entity 320 is at the | Provide to the terminal |
| assuming the entity | terminal device 210. | device 210 |
| 330 is at the third | The entity 320 is at the | No signaling |
| party device. | third party device. | |
| The first AI/ML | The entity 320 is at the | Feedback to the network |
| model is a two sided | network device 220. | device 220 |
| model. | The entity 320 is at the | Indication to the terminal |
| | terminal device 210. | device 210 |
| | The entity 320 is at the | Exchange between the |
| | both the terminal device | network device 220 and |
| | 210 and the network | the terminal device 210 |
| | device 220. | |
| | The entity 320 is at the | Provide to the third |
| | third party device. | party device |

In some embodiments, the information/configuration related to the model monitoring method may be a first configuration of the model monitoring method. For example, the first configuration may include a first set of monitoring metrics related to inference accuracy. The first configuration may be configured to the entity 320 or determined by the entity 320. The inference accuracy may refer to how well does the given monitoring metric/methods reflect the model and system performance. By way of example, the first set of monitoring metrics may include metric(s) related to intermediate key performance indicators (KPIs).

In some embodiments, the inference accuracy may be an accuracy which is a comparison result with ground truth. The comparison results or the configuration to obtain the ground truth may be additionally provided to the entity 320. For example, the comparison result can be different per use case. By way of example, for channel state information (CSI) compression scenario, the comparison result may be at least one of: generalized cosine similarity (CGS), square of GCS (SCGS), minimum means square error (MMSE), or the like. In some other embodiments, for beam prediction scenario, the beam prediction accuracy including Top-1(%) may mean that the percentage of “the Top-1 genie-aided beam is Top-1 predicted beam”, Top-K/1(%) may mean that the percentage of “the Top-1 genie-aided beam is one of the Top-K predicted beams”, and Top-1/K (%) may mean that the percentage of “the Top-1 predicted beam is one of the Top-K genie-aided beams”. In some other embodiments, for positioning scenario, the accuracy may be at least one of: a line of sight (LOS) classification accuracy, a timing estimation accuracy, an angle estimation accuracy and the like. In some embodiments, at least one of the followings may be provided to the entity 320: a comparison threshold, a timer, or a counter for the first AI/ML model.

In some embodiments, the inference accuracy may be a confidence level of prediction. The confidence level may be part of AI/ML model output, and it may be additionally provided to the entity 320. For example, the confidence level may be a value between 0 to 1. In some embodiments, at least one of the followings may be provided to the entity 320: a confidence level threshold, timer, counter of the first AI/ML model.

Alternatively, or in addition, the first configuration may include a second set of monitoring metrics related to system performance. For example, the monitoring KPI(s) of system performance may be additionally provided to the second entity. The second set of monitoring metrics may include one or more of: a throughput, a spectrum efficiency, a hypothetical block error rate (BLER), a BLER, a reference signal received power (RSRP), a signal to noise ratio (SNR), a signal to interference plus noise ratio (SINR), a modulation and coding scheme (MCS), data rate, or overhead. In some embodiments, at least one of the followings may be provided to the entity 320: a system performance KPI threshold, timer, counter of the first AI/ML model.

In some embodiments, the first configuration may include a third set of monitoring metrics related to application condition. The application condition may include one or more of: a scenario condition, a configuration condition, an area condition, a zone condition, a site condition, or a cell condition. The scenario condition may include at least one of: LOS/NLOS, indoor/outdoor, high/medium/low mobility, frequency range 1 (FR1) frequency range, FR2 frequency range. In some embodiments, the configuration condition may comprise one or more of: a configuration identity, the number of beams, or the number of resources. The area condition may include an area identity, the zone condition may include a zone identity, the site condition may include a site identity, and the cell condition may include a cell identity. In some embodiments, at least one of the followings may be provided to the entity 320: a suitable application condition, timer, counter of the first AI/ML model. The entity 320 may determine whether the current application condition is the same as the informed suitable application condition based on a threshold. Alternatively, whether the current application condition is the same as the informed suitable application condition may not be based on the threshold.

In some embodiments, the first configuration may include a fourth set of monitoring metrics related to power consumption. For example, the power consumption may be inference power consumption. In this case, the fourth set of monitoring metrics may be related to the inference power consumption. In some embodiments, at least one of the followings may be provided to the entity 320: a power consumption threshold, timer, counter of the first AI/ML model.

Alternatively, the first configuration may include a fifth set of monitoring metrics related to complexity. In some embodiments, the complexity may refer to a computation cost for model monitoring. In this case, the fifth set of monitoring metrics may relate to the computation cost for model monitoring. Alternatively, or in addition, the complexity may refer to a memory cost for model monitoring. For example, the fifth set of monitoring metrics may be related to the memory cost for model monitoring. In some other embodiments, the complexity may refer to an inference complexity. For example, the fifth set of monitoring metrics may be related to the inference complexity. In some embodiments, the fifth set of monitoring metrics may be measured in one of: ML TOP, ML FLOP or MACs. Alternatively, the fifth set of monitoring metrics may be measured in logic units, for example, AI processing units. In some embodiments, at least one of the followings may be provided to the entity 320: a complexity threshold, timer, counter of the first AI/ML model.

In some embodiments, the first configuration may include a sixth set of monitoring metrics related to storage. The storage may refer to the storage for the first AI/ML model. In some embodiments, the sixth set of monitoring metrics may be related to the storage for the first AI/ML model. Alternatively, or in addition, the storage may refer to the storage for the input/output data. In this case, the sixth set of monitoring metrics may be related to the storage for the input/output data. In some embodiments, at least one of the followings may be provided to the entity 320: a storage threshold, timer, counter of the first AI/ML model.

In some other embodiments, the first configuration a seventh set of monitoring metrics related to latency. In some embodiments, the latency may refer to an inference latency. Given the purpose of model monitoring, the latency may refer to timeliness of monitoring result, from model failure to action.

Alternatively, the information/configuration related to the model monitoring method may comprise a second configuration for monitoring the first AI/ML model. In other words, the second configuration may refer to a general configuration for model monitoring.

In some embodiments, the second configuration may include a set of thresholds related to monitoring metrics for the first AI/ML model. For example, the set of thresholds may include threshold(s) to determine that a model is not performing well. Alternatively, or in addition, the set of thresholds may include threshold(s) to assess a model failure.

The set of thresholds may be different for different model monitoring methods. For example, depending on the model monitoring method, the set of thresholds may be in terms of one or more of: the first set of monitoring metrics related to inference accuracy, the second set of monitoring metrics related to system performance, the third set of monitoring metrics related to application condition, the fourth set of monitoring metrics related to power consumption, the fifth set of monitoring metrics related to complexity, the sixth set of monitoring metrics related to storage, or the seventh set of monitoring metrics related to latency.

In some embodiments, the set of thresholds may be different depending on different actions to improve the performance of the model. For example, in some embodiments, the set of thresholds may include a threshold of fallback to non-AI operation. Alternatively, or in addition, the set of thresholds may include a threshold of fallback to a default AI/ML model. The set of thresholds may include one or more of: a threshold of enhancing data processing of current AI/ML model, a threshold of switching to a different AI/ML model (for example, switching to the second AI/ML model), a threshold of training a new AI/ML model (for example, training the second AI/ML model). Alternatively, the set of thresholds may be in terms of offset which is determined by comparing the first AI/ML model and a different AI/ML model.

In some other embodiments, the second configuration may include a timer. For example, the timer may start based on an occurrence of AI/ML model failure instance. The timer may be configured to evaluate AI/ML model performance in a specific time duration. For example, if the failure instance of the first AI/ML model occurs, the timer may start or restart. In some embodiments, the failure instance of the first AI/ML model may be indicted from a lower layer.

Alternatively, the second configuration may include a counter. For example, the counter may be used to count the number of AI/ML model failure instances. The counter may be configured to count the number of AI/ML model failure instances before declaring the AI/ML model failure. Alternatively, the counter may count the consecutive number of AI/ML model failure instance before declaring AI/ML model failure. In some other embodiments, the counter may count the ratio of AI model failure instances to the AI/ML model success instances. For example, if the failure instance of the first AI/ML model occurs, the counter may start or restarted. A value of the counter may be increased by 1 for a following AI/ML model failure instance. If the value of the counter exceeds a maximum value, the AI/ML model failure can be declared, and the corresponding action may be requested.

In some embodiments, the second configuration may indicate a start for monitoring the first AI/ML model. Alternatively, or in addition, the second configuration may indicate a suspend for monitoring the first AI/ML model. The second configuration may also indicate an end for monitoring the first AI/ML model. In some embodiments, the second configuration may indicate a control for monitoring the first AI/ML model.

In some embodiments, the second configuration may indicate a periodicity for monitoring the first AI/ML model. Alternatively, or in addition, the second configuration may indicate a duty cycle for monitoring the first AI/ML model. In some other embodiments, the second configuration may indicate a time duration for monitoring the first AI/ML model. In some embodiments, the second configuration may indicate a time offset configuration for monitoring the first AI/ML model.

In some embodiments, the second configuration may indicate a capability for the model monitoring method. For example, the capability may indicate supported model monitoring method(s) the entity 320 is able to perform.

In some embodiments, a plurality of first AI/ML models may be monitored. In this case, in some embodiments, the information/configuration related to the model monitoring method may include model identities of the plurality of first AI/ML models. Alternatively, the information/configuration related to the model monitoring method may include model group identities of the plurality of first AI/ML models. In some embodiments, the above mentioned first configuration may be configured for each first AI/ML model in the plurality of first AI/ML models. Alternatively, the above mentioned second configuration may be configured for each first AI/ML model in the plurality of first AI/ML models. In other words, per each AI/ML model or per group of AI/ML models, at least one of the followings may be configured: configuration of the model monitoring method, condition, threshold, timer, counter, start/suspend/end/control signaling for model monitoring, periodicity/duty cycle/time duration/time offset configuration for model monitoring, capability signaling to indicate whether the entity 320 is able to perform the model monitoring method. In some embodiments, at least one of the following capability may also be indicated: the supported number of AI/ML models can be monitored, whether the entity 320 can monitor more than one AI/ML model, or whether to support a default AI/ML model.

The entity 320 monitors (4030) the first AI/ML model based on the model monitoring method. For example, the entity 320 may monitor the metrics of the first AI/ML model that are associated with the model monitoring method. In some embodiments, if the entity 330 is at the network device 220 and the entity 320 is at the terminal device 210, the entity 320 may perform the AI/ML model monitoring of the NW-sided AI/ML mode based on the information/configuration related to the model monitoring method.

If a failure of the first AI/ML model occurs, the entity 320 transmits (4040) first information related to a cause of the failure of the first AI/ML model to the entity 310. Alternatively, if the failure of the first AI/ML model occurs, the entity 320 transmits (4040) fourth information about the model monitoring method for the first AI/ML model to the entity 310. In this way, since the reason that the first AI/ML model does not perform well is indicated, the corresponding entity is able to select right actions for fast recovering the gain of AI/ML operation.

In some embodiments, as mentioned above, the first information related to the cause of the failure of the first AI/ML model may be transmitted to the entity 310. In this case, the entity 310 may determine (4050) the cause of the failure of the first AI/ML model based on the first information.

In some embodiments, the first information may indicate the failure of the first AI/ML model caused by an inference accuracy issue. For example, the failure of the first AI/ML model caused by the inference accuracy issue may include the inference accuracy below an inference accuracy threshold. Alternatively, the failure of the first AI/ML model caused by the inference accuracy issue may comprise a confidence level below a confidence level threshold. In some embodiments, the first information may explicitly indicate a low inference accuracy or low confidence level. Alternatively, the first information may explicitly indicate a value of the accuracy. For example, the value of the accuracy may include one or more of: comparison results with ground truth, a value of the confidence level, or a value of other accuracy KPIs which have been described above. In some other embodiments, the first information may implicitly indicate the failure of the first AI/ML model caused by the inference accuracy issue. For example, the implicit indication may include one or more of: no report, an absence of configuration, a special value, reserved points, or an out-of-range value.

Alternatively, or in addition, the first information may indicate the failure of the first AI/ML model caused by a system performance issue. In some embodiments, the failure of the first AI/ML model caused by the system performance issue may include a degradation in the system performance. For example, the first information may explicitly indicate the degradation in the system performance. Alternatively, the first information may explicitly indicate the value of system performance KPI which has been described above. In some other embodiments, the first information may implicitly indicate the failure of the first AI/ML model caused by the system performance issue. For example, the implicit indication may include at least one of: non-acknowledgment (NACK) for data transmission or a miss of configuration.

In some other embodiments, the first information may indicate the failure of the first AI/ML model caused by a data distribution issue. By way of example, the failure of the first AI/ML model caused by the data distribution issue may include an input data out-of-distribution and/or an output data out-of-distribution. Alternatively, or in addition, the failure of the first AI/ML model caused by the data distribution issue may include an input data distribution drift and/or an output data distribution drift. In some embodiments, the first information may explicitly indicate the input data out-of-distribution and/or the output data out-of-distribution. Alternatively, the first information may explicitly indicate the input data distribution drift and/or output data distribution drift. Alternatively, or in addition, the first information may explicitly indicate one or more of: the distribution of input data and/or output data, data sharing to deliver part (i.e., abnormal data), all input/output data, or the likelihood between the distribution of input data and/or output data for model inference and the distribution of input data and/or output data for model training. In some other embodiments, the first information may implicitly indicate the failure of the first AI/ML model caused by the data distribution issue. For example, the implicit indication may include a request to enhance data processing. Alternatively, the implicit indication may include a configuration for enhancing data processing.

In some embodiments, the first information may indicate the failure of the first AI/ML model caused by an application condition issue. By way of example, the failure of the first AI/ML model caused by the application condition issue may include a mismatched application condition. For example, the first information may explicitly indicate the mismatched application condition for the first AI/ML model. Alternatively, the first information may explicitly indicate a current application condition for the first AI/ML model. The first information may explicitly indicate a change of application condition for the first AI/ML model. In some other embodiments, the first information may implicitly indicate the failure of the first AI/ML model caused by the application condition issue. For example, the implicit indication may include a model switch configuration or a model switch request.

Alternatively, or in addition, the first information may indicate the failure of the first AI/ML model caused by one or more of: a power issue, a storage issue, a complexity issue, or latency associated with the first AI/ML model. For example, the first information may explicitly indicate a power below a power threshold. Alternatively, or in addition, the first information may explicitly indicate a storage resource below a storage resource threshold. In some embodiments, the first information may explicitly indicate a computation resource below a computation resource threshold. In some other embodiments, the first information may explicitly indicate a complexity exceeding a complexity threshold. Alternatively, the first information may explicitly indicate a latency exceeding a latency threshold. In some embodiments, the first information may explicitly indicate one or more of: a value of current power, a value of remaining power, a value of current storage, a value of remaining storage, a value of current computation resource, a value of remaining computation resource, a value of complexity, or a value of latency. In some other embodiments, the first information may implicitly indicate the cause of the failure. For example, the implicit indication may include a fallback request. Alternatively, the implicit indication may include no inference output within given time, or given power, or give resource.

Alternatively, as mentioned above, the fourth information about the model monitoring method for the first AI/ML model may be transmitted to the entity 310. In this case, the entity 310 may determine (4050) the cause of the failure of the first AI/ML model based on the fourth information. In some embodiments, the fourth information may include the first configuration of the model monitoring method of the first AI/ML model. Alternatively, the fourth information may include the second configuration for monitoring the first AI/ML model. Details of the first configuration and the second configuration have been described above and are omitted to avoid redundancy.

By way of example, the entity 310 may determine the cause of the failure of the first AI/ML model based on the monitored metrics associated with the model monitoring method. For example, if the first set of monitoring metrics related to inference accuracy are monitored based on the model monitoring method, the entity 310 may determine the failure of the first AI/ML model caused by the inference accuracy issue. In some embodiments, if the second set of monitoring metrics related to system performance are monitored based on the model monitoring method, the entity 310 may determine the failure of the first AI/ML model caused by the system performance issue. Alternatively, or in addition, if the third set of monitoring metrics related to application condition are monitored based on the model monitoring method, the entity 310 may determine the failure of the first AI/ML model caused by the application condition issue. In some other embodiments, if the fourth set of monitoring metrics related to power consumption are monitored based on the model monitoring method, the entity 310 may determine the failure of the first AI/ML model caused by the power consumption issue. In some embodiments, if the fifth set of monitoring metrics related to complexity are monitored based on the model monitoring method, the entity 310 may determine the failure of the first AI/ML model caused by the complexity issue. Alternatively, or in addition, if the sixth set of monitoring metrics related to storage are monitored based on the model monitoring method, the entity 310 may determine the failure of the first AI/ML model caused by the storage issue. In some embodiments, if the seventh set of monitoring metrics related to latency are monitored based on the model monitoring method, the entity 310 may determine the failure of the first AI/ML model caused by the latency issue.

In some embodiments, if the entity 310 is at the network device 220 and the entity 320 is at the terminal device 210, the terminal device 210 may report the failure of a NW-sided AI/ML model and the cause of the failure to the network device 220. In this case, the network device 220 may perform actions in response to the reporting from the terminal device 210. Alternatively, if the entity 310 is at the terminal device 210 and the entity 320 is at the network device 220, the network device 220 may indicate the failure of a UE-sided AI/ML model and the cause of the failure to the terminal device 210. In this case, the terminal device 210 may perform actions in response to the indicated failure and cause.

In some embodiments, the need of signaling of the first information or the fourth indication may be based on different AI/ML model structure and whether model monitoring entity is the same as the model interference entity and/or the entity needs to take actions. Table 2 below shows an example of signaling exchanges related to the first information or the fourth information.

TABLE 2

| | Entity 320 that is | Signaling exchanges |
|---|---|---|
| | responsible for | related to the first |
| | monitoring the first | information or the |
| | AI/ML model | fourth information |
| The first AI/ML | The entity 320 is at the | No signaling |
| model is at the | network device 220. | |
| network device 220, | The entity 320 is at the | Feedback to the network |
| assuming the entity | terminal device 210. | device 220 |
| 330 is at the | The entity 320 is at the | Provide to the network |
| network device 220. | third party device. | device 220 |
| The first AI/ML | The entity 320 is at the | Indication to the |
| model is at the | network device 220. | terminal device 210 |
| terminal device 210, | The entity 320 is at the | No signaling |
| assuming the entity | terminal device 210. | |
| 330 is at the | The entity 320 is at the | Provide to the terminal |
| terminal device 210. | third party device. | device 210 |
| The first AI/ML | The entity 320 is at the | Provide to the third |
| model is at the third | network device 220. | party device |
| party device, | The entity 320 is at the | Provide to the third |
| assuming the entity | terminal device 210. | party device |
| 330 is at the third | The entity 320 is at the | No signaling |
| party device. | third party device. | |
| The first AI/ML | The entity 320 is at the | Indication to the |
| model is a two sided | network device 220. | terminal device 210 |
| model. | The entity 320 is at the | Feedback to the network |
| | terminal device 210. | device 220 |
| | The entity 320 is at the | Exchange between the |
| | both the terminal device | network device 220 and |
| | 210 and the network | the terminal device 210 |
| | device 220. | |
| | The entity 320 is at the | Provide to the network |
| | third party device. | device 220 and the |
| | | terminal device 210 |

In some embodiments, as mentioned previously, the plurality of AI/ML models may be monitored. In this case, in some embodiments, a plurality of first information related to causes of failures of the plurality of first AI/ML models may be obtained. The plurality of first information may include model identities of the plurality of first AI/ML models that are experiencing model failure. Alternatively, the plurality of first information may include model group identities of the plurality of first AI/ML models that are experiencing model failure. In some embodiments, the above mentioned first information may be configured for each first AI/ML model in the plurality of first AI/ML models. In other words, per each AI/ML model or per group of AI/ML models, the cause of the model failure may be transmitted or determined. In some other embodiments, the fourth information may indicate identities of first AI/ML models in the plurality of first AI/ML models.

The entity 310 determines (4060) one or more of: a first decision or a first action related to the AI/ML management based on the first information related to a cause of the failure of the first AI/ML model and second information related to a status of a second AI/ML model. In some embodiments, the second information may indicate that the second AI/ML model is unavailable. Alternatively, the second information may indicate that the second AI/ML model is not registered. In some other embodiments, the second information may indicate that the second AI/ML model is not received by the first entity. The second information may indicate that the second AI/ML model is not deployed by the first entity. In some embodiments, the second information may indicate that the second AI/ML model is deployed. Alternatively, the second information may indicate that the second AI/ML model is activated. The second information may also indicate that the second AI/ML model is known or selected. In some embodiments, the second information may also indicate that the second AI/ML model is not activated. Alternatively, or in addition, the second information may also indicate that the second AI/ML model is not known or not selected. In this way, it can choose a right action in response of model failure and can fast recover the gain of AI/ML operation.

In some embodiments, the entity 310 may receive the second information from other entity. For example, the network device 220 may provide the status of the NW-sided AI/ML model to the entity 310. Alternatively, or in addition, the terminal device 210 may provide the status of the UE-sided AI/ML model to the entity 310.

In some embodiments, the entity 310 may be able to perform the first action. Alternatively, the first action may be performed by other entity, for example, the entity 410. In some embodiments, the entity 310 or the entity 410 may indicate a capability information for actions in response to AI/ML model failure. Alternatively, the capability information for actions in response to AI/ML model failure may be provided to the entity 310 or the entity 410. In this case, in some embodiments, the entity 310 may determine (4060) one or more of: the first decision or the first action related to the AI/ML management based on the first information related to a cause of the failure of the first AI/ML model and second information related to a status of a second AI/ML model and the capability information of the entity 310/410. The capability information may indicate which first action(s) can be supported and/or which first action(s) cannot be supported by the entity 310 or entity 410. In some other embodiments, the capability information may be exchanged among the terminal device 210, the network device 220 or the third party device.

In some embodiments, the entity 310 may determine (4060) one or more of: the first decision or the first action related to the AI/ML management based on the first information related to a cause of the failure of the first AI/ML model and second information related to a status of a second AI/ML model and the requirement of the first decision or the first action. Examples and details of the requirement are described later.

In some embodiments, the first decision may include one or more of: applying the first AI/ML mode, switching to the second AI/ML model, training the second AI/ML model, falling back to a default AI/ML model, or stopping using AI/ML. In some embodiments, the first action may include at least one of: a registration of the second AI/ML model, a transfer of the second AI/ML model, a deployment of the second AI/ML model, an activation of the second AI/ML model, a deactivation of the second AI/ML model, an update of the second AI/ML 5 model, a training of the second AI/ML model, or an enhanced data processing of the first AI/ML model. Table 3 provides a summary of different decisions and actions that may be taken if the model failure is detected. Details of the first decision and the first action are described later.

TABLE 3

| 1st | 2nd | 1st | 1st | 2nd | 2nd |
|---|---|---|---|---|---|
| level | level | level | level | level | level |
| Decision | Decision | status | Action | status | Action |
| not use | | | fall back to | — | — |
| AI/ML | | | non-AI | | |
| still use | default | the model | fall back | | |
| AI/ML | model | is known at | to default | | |
| | | the entity | AI/ML | | |
| | | performing | model | | |
| | | model | | | |
| | | inference | | | |
| | use the same | the model | enhance pre- | | |
| | AI/ML | is still in | processing of | | |
| | model | use/ | inference | | |
| | | activated | input; | | |
| | | status | enhance | | |
| | | | post- | | |
| | | | processing of | | |
| | | | inference | | |
| | | | output | | |
| | use a | the model | model | | transfer- |
| | different | is not | registration | | deploy- |
| | but existing | registered | | | activate |
| | AI/ML | yet | | | |
| | model | the model | model | | deploy- |
| | | is not | transfer (or | | activate |
| | | received yet | model | | |
| | | (but already | delivery) | | |
| | | registered) | | | |
| | | the model | model | | activate |
| | | is not | deployment | | |
| | | deployed yet | | | |
| | | (but already | | | |
| | | received) | | | |
| | | the model | model | | use the |
| | | is already | activation/ | | activated |
| | | deployed | model | | model |
| | | | switching | | |
| | | the model is | model | | use the |
| | | already | switching/ | | model |
| | | activated | model | | |
| | | | selection | | |
| | need a new | the new | model | w/o | register- |
| | AI/ML | model is not | update | new | transfer- |
| | model | available | model | data | deploy- |
| | (including | yet | training | | activate |
| | tuning) | | | with | data |
| | | | | new | collection |
| | | | | data | for model |
| | | | | | training- |
| | | | | | register- |
| | | | | | . . . |

The first action may be different based on the status of the second AI/ML model. FIG. 5 shows an example of status of the second AI/ML model and corresponding actions. In some embodiments, if the status indicates that the second AI/ML model is not available, the first action may be a model training (510) or tunning of the second AI/ML model. In some embodiments, the status may indicate that the second AI/ML model is registered. For example, the second AI/ML model may be available (for example, training of the second AI/ML model is completed) but not registered yet. In this case, the first action may be a model registration (520). Alternatively, the status may indicate that the second AI/ML model is not received. For example, the second AI/ML model may be registered (i.e., already assigned with a model-ID) but not received. In this case, the first action may be a model transfer (530) or delivery. In some other embodiments, the status may indicate that the second AI/ML model is not deployed. In this case, the first action may be a model deployment (540). In some embodiments, the second AI/ML model may be deployed, for example, the runtime environment for the second AI/ML model is ready. In this case, the first action may be a model activation. Alternatively, the status may indicate that the second AI/ML model is activated. In this case, the first action may be a model switching. In some other embodiments, the second AI/ML model may be known. In other words, it is a more general status for available models. In this case, at least the entity for model inference is aware of the existence of such a model. In addition, the status may indicate that the second AI/ML model is selected. The first action may also include one or more of: a model selection or a model deactivation. It is noted that the first action may also include other actions that are not shown in FIG. 5.

In some embodiments, the first decision may be a fallback to non-AI/ML mode or non-AI/ML method. For example, if the second AI/ML model is not available, the fallback to non-AI/ML mode may be applied. In some embodiments, if the cause of the first AI/ML model is one of: a degradation of the system performance, a low prediction accuracy, a low power or a low storage, the fallback to non-AI/ML mode may be applied. In this case, in some embodiments, a configuration of performing the non-AI/ML method may be available at the entity for model inference (for example, the entity 330). The configuration may be of normal measurement report. For example, the configuration may be related to CSI measurement and report. Alternatively, the configuration may be related to measurement and report for beam management. The configuration may be related to measurement and report for poisoning information. In some embodiments, the entity 310 may transmit at least one of the followings of the non-AI/ML operation: a request, a notification or a suggest. Alternatively, a signaling related to one or more of: a configuration, an activation, or a trigger of the non-AI/ML operation may be exchanged. In some other embodiments, an implicit application of the non-AI/ML operation may be based on a specific cause of the failure.

Alternatively, the first decision may be a fallback to a default AI/ML model. For example, if the default AI/ML model is known at the model inference entity (i.e., the entity 330), the fallback to the default AI/ML model may be applied. In some embodiments, if the cause of the first AI/ML model is one of: a low prediction accuracy or a wrong application condition, the fallback to the default AI/ML model may be applied. In some embodiments, the default AI/ML model may be an AI/ML model with a better generalization performance. Alternatively, the default AI/ML model may be a previously working AI/ML model. In some other embodiments, the default AI/ML model may be an AI/ML model with a specific model ID. In some embodiments, the entity 310 may transmit at least one of the followings of the default AI/ML model: a request, a notification or a suggest. Alternatively, a signaling related to one or more of: a configuration, an activation, or a trigger of the default AI/ML model may be exchanged. In some other embodiments, an implicit application of the default AI/ML model may be based on a specific cause of the failure.

In some other embodiments, the first decision may be applying the first AI/ML model. For example, if the second AI/ML model is the same as the first AI/ML model, the first AI/ML model may still be used. In some embodiments, if the cause of the first AI/ML model is one of: an inference input distribution or an inference output data distribution, the first AI/ML model may still be applied. In this case, the first action may be the enhanced data processing of the first AI/ML model. For example, the pre-processing of input data may be improved. In some embodiments, the input data may be clean. For example, the abnormal input data (for example, for the out-of-distribution data) may be removed. Alternatively, a threshold for input data of the first AI/ML model may be updated. For example, the threshold may be raised to have high quality input data. In some embodiments, the input data may be augmented. For example, more data samples (for example, historical data) may be included into the input data. In some embodiments, existing data samples may be randomized to enlarge the dataset of the input data. Alternatively, additional data may be generated, for example, using a generative adversarial network (GAN) method.

In some embodiments, the post-processing of output data may be improved. In some embodiments, the output data may be clean. For example, the abnormal output data (for example, for the out-of-distribution data) may be removed. Alternatively, the output data with low confidence level may be removed.

Alternatively, the processing of intermediate data may be improved. In some embodiments, the intermediate data resolution may be enhanced. For example, more bits may be assigned to represent the intermediate data.

In some embodiments, the entity 310 may transmit at least one of the followings of to enhance the data processing: a request, a notification or a suggest. Alternatively, a signaling related to one or more of: a configuration, an activation, or a trigger to enhance the data In some other embodiments, an implicit application of processing may be exchanged. enhanced data processing may be based on a specific cause of the failure.

Alternatively, or in addition, still applying the firs AI/ML model may include a fine-tuning of the first AI/ML model. Alternatively, still applying the firs AI/ML model may include a minor update of the first AI/ML model.

In some embodiments, the first decision may be switching to the second AI/ML model. For example, if the status of the second AI/ML model is one of: known, available, registered, received, deployed, or activated, the second AI/ML model may be switched to. In some embodiments, if the cause of the first AI/ML model is a wrong application condition, the second AI/ML model may be switched to. In some embodiments, the switching may be a model-ID based switching. In some embodiments, compared with the first AI/ML model, the second AI/ML model may include one or more of the following properties: required less time to perform inference, required less resource to perform inference, required less power to perform inference, suitable for a different application condition, suitable for a different input/output data distribution, or a better performance (for example, accuracy or generalization performance).

In some embodiments, if the second AI/ML model is not registered yet, the first action may include: the model registration, the model transfer, the model deployment, and the model activation. Alternatively, if the second AI/ML model is not received yet, the first action may include: the model transfer, the model deployment, and the model activation. In some other embodiments, if the second AI/ML model is not deployed yet, the first action may include: the model deployment and the model activation. In some embodiments, if the second AI/ML model is already deployed, the first action may include the model activation. Alternatively, if the second AI/ML model is already activated, the first action may include the model switching. In some embodiments, the entity 310 may transmit at least one of the followings of the first action for the second AI/ML model: a request, a notification or a suggest. Alternatively, a signaling related to one or more of: a configuration, an activation, or a trigger of the first action for the second AI/ML model may be exchanged. In some other embodiments, an implicit application of the first action for the second AI/ML model may be based on a specific cause of the failure.

In some embodiments, the first decision may be finding a new AI/ML model which is different from the first AI/ML model. For example, if the status of the second AI/ML model is not available, a new AI/ML model may be needed. In other words, if the current second AI/ML model is unavailable, the new AI/ML model may be regarded as another second AI/ML model. In some embodiments, if the cause of the first AI/ML model is one of: a degradation of the system performance, a low inference accuracy, no suitable application or no matched data distribution, the new AI/ML model may be needed. In some embodiments, finding the new

AI/ML model may include a model training or model update with new data. In this case, the first action may include: a data collection, the model training, the model registration, the model transfer, the model deployment, and the model activation. Alternatively, finding the new AI/ML model may include a model training or model update without new data. In this case, the first action may include: the model training, the model registration, the model transfer, the model deployment, and the model activation. In some embodiments, the model training or model update may result in a completely new AI/ML model. Alternatively, the model training or model update may result in changes in part of the first AI/ML model. In some embodiments, the entity 310 may transmit at least one of the followings of to train the new AI/ML model: a request, a notification or a suggest. Alternatively, a signaling related to one or more of: a configuration, an activation, or a trigger of the training of the new AI/ML model may be exchanged. In some other embodiments, an implicit application of the training of the new AI/ML model may be based on a specific cause of the failure. In some embodiments, if new data is involved in the model training or model update, the new data may be shared. For example, the new data may be provided to the entity responsible for model training.

Alternatively, the first action may include a deactivation of the first AI/ML model. For example, the deactivation of the first AI/ML model may be performed if the failure of the first AI/ML model is declared and the first decision is not to keep the same AI/ML model. For example, the deactivation of the first AI/ML model may be applied, if one of the following decision is made: the fallback to non-AI/ML method, the fallback to the default AI/ML mode, the switching to the second AI/ML model, the training the new AI/ML model.

In some other embodiments, the first action may include a model selection. For example, the model selection may be different from model switching on the assumptions that the failed first AI/ML model may not be activated. The model selection may refer to selecting the second AI/ML model to be applied from activated AI/ML models.

In some embodiments, as mentioned previously, the plurality of AI/ML models may be monitored. In this case, in some embodiments, a plurality of second information related to statuses of the plurality of second AI/ML models may be obtained. The plurality of second information may include model identities of the plurality of second AI/ML models. Alternatively, the plurality of second information may include model group identities of the plurality of second AI/ML models. In some embodiments, the above mentioned second information may be configured for each second AI/ML model in the plurality of second AI/ML models. In other words, per each second AI/ML model or per group of second AI/ML models, the status of the model may be transmitted or determined. In this situation, the entity 310 may determine a plurality of first decisions and/or a plurality of first actions based on the plurality of first information and the plurality of second information. In other words, per each first AI/ML model or per group of first AI/ML models, the first decision and/or the action may be determined.

The entity 310 may transmit (4070) a request for the first decision and/or the first action to an entity 410 which is responsible for taking the first action. The entity 410 may be at the terminal device 210. Alternatively, the entity 410 may be at the network device 220. In some other embodiments, the entity 410 may be at the third party device. Alternatively, the 5 entity 310 itself may take the first action.

In some embodiments, the need of signaling to exchange the first decision and/or signaling to enable the first action in response to model failure may be based on different AI/ML model structure and whether the entity needs to take actions and/or the entity needs to make decision is the same as the model interference entity and/or model monitoring entity. Table 4 below shows an example of signaling exchanges related to the first decision and/or the first action.

TABLE 4

| | Entity 410 that is | Signaling to exchange |
|---|---|---|
| | responsible for | decision and/or to |
| | taking the first | enable actions in |
| | action | response to model failure |
| The first AI/ML | The entity 410 is at the | No signaling |
| model is at the | network device 220. | |
| network device 220, | The entity 410 is at the | Configuration/ |
| assuming the entity | terminal device 210. | activation/trigger |
| 330 is at the | The entity 410 is at the | Provide to the third |
| network device 220. | third party device. | party device |
| The first AI/ML | The entity 410 is at the | Request/notification/ |
| model is at the | network device 220. | suggest |
| terminal device 210, | The entity 410 is at the | No signaling |
| assuming the entity | terminal device 210. | |
| 330 is at the | The entity 410 is at the | Provide to the third |
| terminal device 210. | third party device. | party device |
| The first AI/ML | The entity 410 is at the | Provide to the network |
| model is at the third | network device 220. | device 220 |
| party device, | The entity 410 is at the | Provide to the terminal |
| assuming the entity | terminal device 210. | device 210 |
| 330 is at the third | The entity 410 is at the | No signaling |
| party device. | third party device. | |
| The first AI/ML | The entity 410 is at the | Request/notification/ |
| model is a two sided | network device 220. | suggest |
| model. | The entity 410 is at the | Configuration/ |
| | terminal device 210. | activation/trigger |
| | The entity 410 is at the | Alignment on the |
| | both the terminal device | actions |
| | 210 and the network | |
| | device 220. | |
| | The entity 410 is at the | Provide to the third |
| | third party device. | party device |

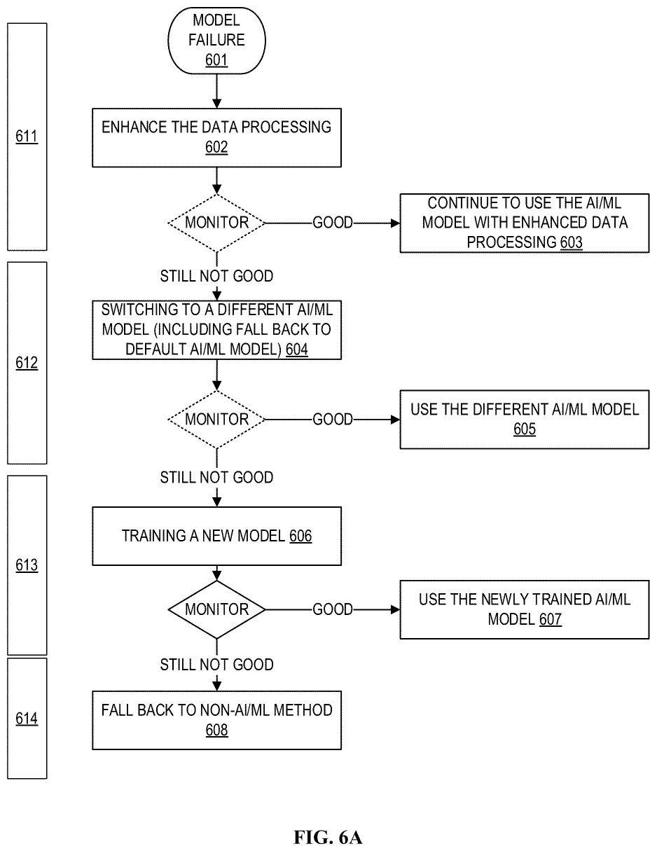

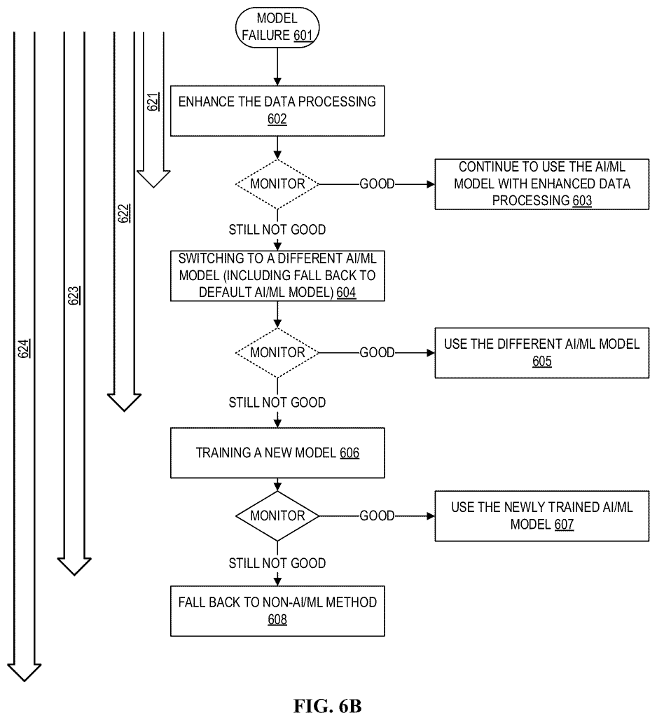

In some embodiments, a plurality of first actions may be taken jointly. In some embodiments, the plurality of first actions may include possible combination of actions can be configured/reported/selected. In this case, a plurality of timers may be configured. All timers may stop or set to 0 when the model monitoring gives positive results, for example, a successful inference. FIG. 6A and FIG. 6B illustrate schematic diagrams of a method where the plurality of first actions are taken, respectively. It is noted that FIGS. 6A and 6b is only an example not limitation.

Referring to FIG. 6A, the timer 611 may start first. During the running time of the timer 611, the data processing may be enhanced (602). The performance of the first AI/ML model may be then monitored. If the performance is good enough, the first AI/ML model with enhanced data processing may be used (603). After the expiration of the timer 611, the timer 612 may start. If the performance is still not good, a different AI/ML model may be switched to (604), during the running time of the timer 612. The performance of the first AI/ML model may be then monitored. If the performance is good enough, the different AI/ML model may be used (605). After the timer 612 expires, the timer 613 may start. If the performance is still not good, a new AI/ML model may be trained (606). The performance of the first AI/ML model may be then monitored. If the performance is good enough, the newly trained AI/ML model may be used (607).

After the timer 613 expires, the timer 614 may start. If the performance is still not good, the non AI/ML method may be fallen back (608).

Referring to FIG. 6B, all timers 621, 622, 623 and 624 may start if the model failure is declared (601) for the first AI/ML model. During the running time of the timer 621, the data processing may be enhanced (602). The performance of the first AI/ML model may be then monitored. If the performance is good enough, the first AI/ML model with enhanced data processing may be used (603). The timer 621 expires while the timer 622 is still running. In other words, the time length of the timer 622 is longer than the time length of the timer 621. If the performance is still not good, a different AI/ML model may be switched to (604), during the running time of the timer 622. The performance of the first AI/ML model may be then monitored. If the performance is good enough, the different AI/ML model may be used (605). The timer 622 expires while the timer 623 is still running. In other words, the time length of the timer 623 is longer than the time length of the timer 622. If the performance is still not good, a new AI/ML model may be trained (606). The performance of the first AI/ML model may be then monitored. If the performance is good enough, the newly trained AI/ML model may be used (607). The timer 623 expires while the timer 624 is still running. In other words, the time length of the timer 624 is longer than the time length of the timer 623. If the performance is still not good, the non AI/ML method may be fallen back (608).

As mentioned previously, the first decision and/or the first action may also be determined based on requirement of the first decision or the first action. In some embodiments, the first action may be associated with a latency requirement for the AI/ML management. For example, different actions in response to model failure may be associated with different requirements. The latency requirement may refer to a required duration from model failure to model success. For example, Tₛₜₐᵣₜ can be the time point when model failure declared, model failure information is reported/received to other entity, decision is made, or action is to be taken, etc. Taction can be the time length needed to complete the required actions of model failure. In some embodiments, before Tₛₜₐᵣₜ+T_{action}, the first AI/ML model may be used. Alternatively, the first AI/ML model may be deactivated. For example, a non-AI method, a default AI/ML model, or a still-perform-good AI/ML model may be used. In some embodiments, after Tₛₜₐᵣₜ+T_{action}, the second AI/ML model (including switching/selection/indicated/updated/trained model, or with enhanced data processing) may be used.

In some embodiments, different actions may need different time lengths, for example, in the following order: “fall-back to non-AI”< “enhance data processing for the same AI/ML model”< “switch to an existing AI/ML model”< “training a new AI/ML mode.” In some embodiments, within “switch to an existing AI/ML model”, the time lengths may be in the following order: “not available”>“available but not registered yet”>“registered but not received yet”>“received but not deployed yet”>“deployed but not activated”>“activated.” Alternatively, within “training a new AI/ML mode”, the time lengths may be in the following order: “training a new AI/ML mode without new data”< “training a new AI/ML mode with new data”, or “model update with part of parameters” < “model training for a complete new AI/ML mode”.

Alternatively, or in addition, the latency requirement may further include one or more of: the requirement of latencies from model failure to action, from action to recovery, or the requirement of latencies from model failure to decision, from decision to action.

In some embodiments, the entity 320 may be expected to give positive outcome before Tₛₜₐᵣₜ+T_{action}. In addition, the terminal device 210 or the network device 220 may be expected to receive signaling about that the second AI/ML model is performing well. If after Tₛₜₐᵣₜ+T_{action}, the entity 320 may still give negative outcome. In this case, model recovery can be considered as failed. This can be achieved by defining a model recovery timer to control the overall time can be spent on model recovery.

In addition, or alternatively, at least one of the followings for the AI/ML management may be defined: an overhead requirement, a storage requirement, a complexity requirement, or a power consumption requirement. In some embodiment, if at least one of the followings runs out: overhead, storage, complexity, or power consumption for the model recovery, the model monitoring may still give negative outcome. In this case, model recovery can be considered as failed. In some embodiments, the above-mentioned requirements may be predefined, for example, predefined in protocols. Alternatively, the above-mentioned requirements may be configured by the network device 220. In some other embodiments, the above-mentioned requirements may be reported by the terminal device 210. In some embodiments, the above-mentioned requirements may be informed by the third party device.

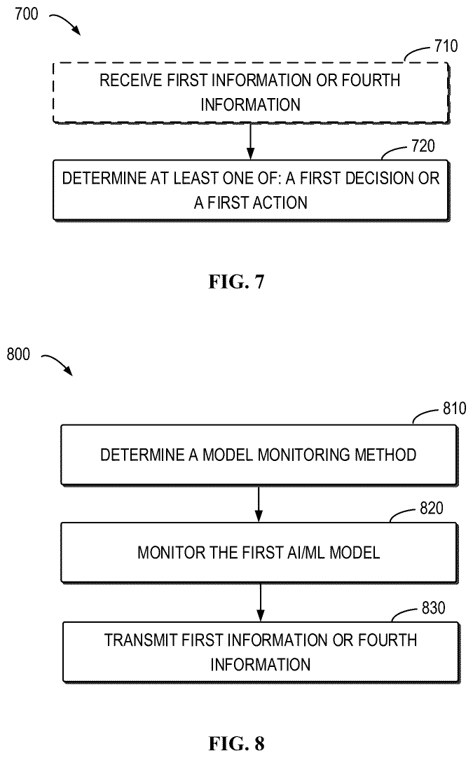

FIG. 7 illustrates a flowchart of a communication method 700 implemented at a first entity (for example, the entity 310) in accordance with some embodiments of the present disclosure. The first entity may be implemented at one of: the terminal device 210, the network device 220, or the third party device.

In some embodiments, at block 710, the first entity may receive first information related to a cause of the failure of the first AI/ML model or fourth information about the model monitoring method for the first AI/ML model from the entity 320.

In some embodiments, the first information indicates at least one of: the failure of the first AI/ML model caused by an inference accuracy issue, the failure of the first AI/ML model caused by a system performance issue, the failure of the first AI/ML model caused by a data distribution issue, the failure of the first AI/ML model caused by an application condition issue, or the failure of the first AI/ML model caused by one or more of: a power issue, a storage issue, a complexity issue, or latency associated with the first AI/ML model. In some embodiments, the failure of the first AI/ML model caused by the inference accuracy issue comprises at least one of: the inference accuracy below an inference accuracy threshold, or a confidence level below a confidence level threshold. In some embodiments, the failure of the first AI/ML model caused by the system performance issue comprises: a degradation in the system performance. In some embodiments, the failure of the first AI/ML model caused by the data distribution issue comprises at least one of: an input data out-of-distribution, an output data out-of-distribution, an input data distribution drift, an output data distribution drift. In some embodiments, the failure of the first AI/ML model caused by the application condition issue comprises: a mismatched application condition. In some embodiments, the failure of the first AI/ML model is also caused by at least one of: a power below a power threshold, a storage resource below a storage resource threshold, a computation resource below a computation resource threshold, a complexity exceeding a complexity threshold, or a latency exceeding a latency threshold.

In some embodiments, the first entity may receive, from a second entity, the first information indicating the cause of the failure of the first AI/ML model. The first entity may determine the cause of the failure of the first AI/ML model based on the first information.

In some embodiments, the first entity may receive, from a second entity, fourth information about a model monitoring method for the first AI/ML model. The first entity may determine the cause of the failure of the first AI/ML model based on the fourth information.

In some embodiments, the fourth information about the model monitoring method comprises a first configuration of the model monitoring method of the first AI/ML model. In some embodiments, the first configuration comprises at least one of: a first set of monitoring metrics related to inference accuracy, a second set of monitoring metrics related to system performance, a third set of monitoring metrics related to application condition, a fourth set of monitoring metrics related to power consumption, a fifth set of monitoring metrics related to complexity, a sixth set of monitoring metrics related to storage, or a seventh set of monitoring metrics related to latency.

In some embodiments, the fourth information about the model monitoring method comprises a second configuration for monitoring the first AI/ML model. In some embodiments, the second configuration at least one of: a set of thresholds related to monitoring metrics for the first AI/ML model, a timer which starts based on an occurrence of AI/ML model failure instance, a counter for the number of AI/ML model failure instances, a start for monitoring the first AI/ML model, a suspend for monitoring the first AI/ML model, an end for monitoring the first AI/ML model, a control for monitoring the first AI/ML model, a periodicity for monitoring the first AI/ML model, a duty cycle for monitoring the first AI/ML model, a time duration for monitoring the first AI/ML model, a time offset configuration for monitoring the first AI/ML model, or a capability for the model monitoring method.

In some embodiments, if a plurality of first AI/ML models are monitored, the fourth information may indicate identities of first AI/ML models in the plurality of first AI/ML models.

At block 720, the first entity determines at least one of: a first decision or a first action related to an AI/ML model management, if a failure of a first AI/ML model occurs. At least one of the first decision or the first action is determined based on: first information related to a cause of the failure of the first AI/ML model and second information related to a status of a second AI/ML model.

In some embodiments, the first decision comprises at least one of: applying the first AI/ML mode, switching to the second AI/ML model, training a new AI/ML model that is different from the second AI/ML model, falling back to a default AI/ML model, or stopping using AI/ML.

In some embodiments, the first action comprises at least one of: a fallback to non-AI/ML method, a registration of the second AI/ML model, a transfer of the second AI/ML model, a deployment of the second AI/ML model, an activation of the second AI/ML model, a deactivation of the second AI/ML model, an update of the second AI/ML model, a training of the second AI/ML model, or an enhanced data processing of the first AI/ML model.

In some embodiments, the enhanced data processing of the first AI/ML model comprises at least one of: an updated threshold for input data of the first AI/ML model, an augmentation of the input data, or a remove of output data of the first AI/ML model that is with a confidence level below a confidence level threshold.

In some embodiments, the second information indicates at least one of: the second AI/ML model is unavailable, the second AI/ML model is not registered, the second AI/ML model is not received by the first entity, the second AI/ML model is not deployed by the first entity, the second AI/ML model is deployed, the second AI/ML model is activated, the second AI/ML model is known, or the second AI/ML model is selected.

In some embodiments, the first configuration is configured for each first AI/ML model in the plurality of first AI/ML models. In some embodiments, the second configuration is configured for each first AI/ML model in the plurality of first AI/ML models. In some embodiments, the first action is associated with a latency requirement for the AI/ML management.

In some embodiments, the first entity may receive, from a third entity, the second information indicating the status of the second AI/ML model. In some embodiments, the first entity may transmit, to a fourth entity, a request for at least one of: the first decision or the first action performed by the fourth entity.

In some embodiments, if a plurality of first AI/ML models are failed, the first entity may obtain a plurality of first information related to causes of failures of the plurality of first AI/ML models. The first entity may obtain a plurality of second information related to statuses of the plurality of second AI/ML models. The first entity may determine at least one of: a plurality of first decisions and a plurality of first actions based on the plurality of first information and the plurality of second information.

FIG. 8 illustrates a flowchart of a communication method 800 implemented at a second entity (for example, the entity 320) in accordance with some embodiments of the present disclosure. The second entity may be implemented at one of: the terminal device 210, the network device 220, or the third party device.

At block 810, the second entity determines model monitoring method for a first AI/ML model.

At block 820, the second entity monitors the first AI/ML model based on the model monitoring method.

At block 830, in accordance with a determination of a failure of the first AI/ML model, the second entity transmits one of the followings to a first device: first information related to a cause of the failure of the first AI/ML model, or fourth information about a model monitoring method for the first AI/ML model.

In some embodiments, the first information indicates at least one of: the failure of the first AI/ML model caused by an inference accuracy issue, the failure of the first AI/ML model caused by a system performance issue, the failure of the first AI/ML model caused by a data distribution issue, the failure of the first AI/ML model caused by an application condition issue, or the failure of the first AI/ML model caused by one or more of: a power issue, a storage issue, a complexity issue, or latency associated with the first AI/ML model.

In some embodiments, the failure of the first AI/ML model caused by the inference accuracy issue comprises at least one of: the inference accuracy below an inference accuracy threshold, or a confidence level below a confidence level threshold. In some embodiments, the failure of the first AI/ML model caused by the system performance issue comprises: a degradation in the system performance. In some embodiments, the failure of the first AI/ML model caused by the data distribution issue comprises at least one of: an input data out-of-distribution, an output data out-of-distribution, an input data distribution drift, an output data distribution drift. In some embodiments, the failure of the first AI/ML model caused by the application condition issue comprises: a mismatched application condition. In some embodiments, the failure of the first AI/ML model is also caused by at least one of: a power below a power threshold, a storage resource below a storage resource threshold, a computation resource below a computation resource threshold, a complexity exceeding a complexity threshold, or a latency exceeding a latency threshold.

In some embodiments, determining the model monitoring method comprises: receiving from a third device a first configuration of the model monitoring method of the first AI/ML model; and determining the model monitoring method based on the first configuration.

In some embodiments, the first configuration comprises at least one of: a first set of monitoring metrics related to inference accuracy, a second set of monitoring metrics related to system performance, a third set of monitoring metrics related to application condition, a fourth set of monitoring metrics related to power consumption, a fifth set of monitoring metrics related to complexity, a sixth set of monitoring metrics related to storage, or a seventh set of monitoring metrics related to latency.

In some embodiments, the fourth information about the model monitoring method comprises the first configuration of the model monitoring method of the first AI/ML model.

In some embodiments, determining the model monitoring method comprises: receiving from a third device a second configuration for monitoring the first AI/ML model; and determining the model monitoring method based on the first configuration.

In some embodiments, the second configuration comprises at least one of: a set of thresholds related to monitoring metrics for the first AI/ML model, a timer which starts based on an occurrence of AI/ML model failure instance, a counter for the number of AI/ML model failure instances, a start for monitoring the first AI/ML model, a suspend for monitoring the first AI/ML model, an end for monitoring the first AI/ML model, a control for monitoring the first AI/ML model, a periodicity for monitoring the first AI/ML model, a duty cycle for monitoring the first AI/ML model, a time duration for monitoring the first AI/ML model, a time offset configuration for monitoring the first AI/ML model, or a capability for the model monitoring method.

In some embodiments, the fourth information about the model monitoring method comprises the second configuration for monitoring the first AI/ML model.

In some embodiments, if a plurality of first AI/ML models are monitored, the fourth information further indicates identities of first AI/ML models in the plurality of first AI/ML models.

In some embodiments, the first configuration is configured for each first AI/ML model in the plurality of first AI/ML models, or the second configuration is configured for each first AI/ML model in the plurality of first AI/ML models.

In some embodiments, if a plurality of first AI/ML models are monitored, the first information related to causes of failures of the plurality of first AI/ML models.

In some embodiments, the first entity is implemented on a terminal device and the second entity is implemented on a network device, or first entity is implemented on the network device and the second entity is implemented on the terminal device.

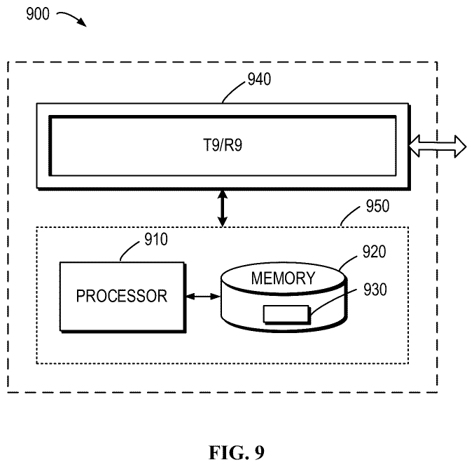

FIG. 9 is a simplified block diagram of a device 900 that is suitable for implementing embodiments of the present disclosure. The device 900 can be considered as a further example implementation of any of the devices as shown in FIG. 1. Accordingly, the device 900 can be implemented at or as at least a part of the terminal device 210 or the network device 220.

As shown, the device 900 includes a processor 910, a memory 920 coupled to the processor 910, a suitable transmitter (TX)/receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a communication device comprises a circuitry configured to: determine at least one of: a first decision or a first action related to an artificial intelligence/machine learning (AI/ML) model management, in accordance with a determination of a failure of a first AI/ML model, and wherein at least one of the first decision or the first action is determined based on: first information related to a cause of the failure of the first AI/ML model and second information related to a status of a second AI/ML model.

According to embodiments of the present disclosure, the circuitry may be configured to perform any of the method implemented by the first entity as discussed above.

In some embodiments, a communication device comprises a circuitry configured to: determine a model monitoring method for a first AI/ML model; monitor the first AI/ML model based on the model monitoring method; and in accordance with a determination of a failure of the first AI/ML model transmit one of the followings to a first device: first information related to a cause of the failure of the first AI/ML model, or fourth information about a model monitoring method for the first AI/ML model.

According to embodiments of the present disclosure, the circuitry may be configured to perform any of the method implemented by the second entity as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In an aspect, a communication device comprises: at least one processor; and at least one memory coupled to the at least one processor and storing instructions thereon, the instructions, when executed by the at least one processor, causing the communication device to perform the method implemented by the communication device discussed above.

In an aspect, a computer readable medium having instructions stored thereon, the instructions, when executed on at least one processor, causing the at least one processor to perform the method implemented by the communication device discussed above.

In an aspect, a computer program comprising instructions, the instructions, when executed on at least one processor, causing the at least one processor to perform the method implemented by the communication device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A communication method, comprising:
determining, at a first entity, at least one of: a first decision or a first action related to an artificial intelligence/machine learning (AI/ML) model management, in accordance with a determination of a failure of a first AI/ML model, and
wherein at least one of the first decision or the first action is determined based on: first information related to a cause of the failure of the first AI/ML model and second information related to a status of a second AI/ML model.

2. The method of claim 1, wherein the first decision comprises at least one of:
applying the first AI/ML mode,
switching to the second AI/ML model,
training a new AI/ML model different from the second AI/ML model, falling back to a default AI/ML model, or
stopping using AI/ML.

3. The method of claim 1 or 2, wherein the first action comprises at least one of:
a registration of the second AI/ML model,
a transfer of the second AI/ML model,
a deployment of the second AI/ML model,
an activation of the second AI/ML model,
a deactivation of the second AI/ML model,
an update of the second AI/ML model,
a training of the second AI/ML model, or
an enhanced data processing of the first AI/ML model.

4. The method of claim 3, wherein the enhanced data processing of the first AI/ML model comprises at least one of:
an updated threshold for input data of the first AI/ML model,
an augmentation of the input data, or
a remove of output data of the first AI/ML model that is with a confidence level below a confidence level threshold.

5. The method of any of claims 1-4, wherein the second information indicates at least one of:
the second AI/ML model is unavailable,
the second AI/ML model is not registered,
the second AI/ML model is not received by the first entity,
the second AI/ML model is not deployed by the first entity,
the second AI/ML model is deployed,
the second AI/ML model is activated,
the second AI/ML model is known, or
the second AI/ML model is selected.

6. The method of any of claims 1-5, wherein the first information indicates at least one of:
the failure of the first AI/ML model caused by an inference accuracy issue,
the failure of the first AI/ML model caused by a system performance issue,
the failure of the first AI/ML model caused by a data distribution issue,
the failure of the first AI/ML model caused by an application condition issue, or
the failure of the first AI/ML model caused by one or more of: a power issue, a storage issue, a complexity issue, or latency associated with the first AI/ML model.

7. The method of claim 6, wherein the failure of the first AI/ML model caused by the inference accuracy issue comprises at least one of:
the inference accuracy below an inference accuracy threshold, or a confidence level below a confidence level threshold; or
wherein the failure of the first AI/ML model caused by the system performance issue comprises:
a degradation in the system performance; or
wherein the failure of the first AI/ML model caused by the data distribution issue comprises at least one of:
an input data out-of-distribution,
an output data out-of-distribution,
an input data distribution drift,
an output data distribution drift, or
wherein the failure of the first AI/ML model caused by the application condition issue comprises:
a mismatched application condition,
wherein the failure of the first AI/ML model is also caused by at least one of:
a power below a power threshold,
a storage resource below a storage resource threshold,
a computation resource below a computation resource threshold,
a complexity exceeding a complexity threshold, or
a latency exceeding a latency threshold.

8. The method of any of claims 1-7, further comprising:
receiving, from a second entity, the first information indicating the cause of the failure of the first AI/ML model; and
determining the cause of the failure of the first AI/ML model based on the first information.

9. The method of any of claims 1-7, further comprising:
receiving, from a second entity, fourth information about a model monitoring method for the first AI/ML model; and
determining the cause of the failure of the first AI/ML model based on the fourth information.

10. The method of claim 9, wherein the fourth information about the model monitoring method comprises a first configuration of the model monitoring method of the first AI/ML model, and
the first configuration comprises at least one of:
a first set of monitoring metrics related to inference accuracy,
a second set of monitoring metrics related to system performance,
a third set of monitoring metrics related to application condition,
a fourth set of monitoring metrics related to power consumption,
a fifth set of monitoring metrics related to complexity,
a sixth set of monitoring metrics related to storage, or
a seventh set of monitoring metrics related to latency.

11. The method of claim 9, wherein the fourth information about the model monitoring method comprises a second configuration for monitoring the first AI/ML model, and
wherein the second configuration at least one of:
a set of thresholds related to monitoring metrics for the first AI/ML model,
a timer which starts based on an occurrence of AI/ML model failure instance,
a counter for the number of AI/ML model failure instances,
a start for monitoring the first AI/ML model,
a suspend for monitoring the first AI/ML model,
an end for monitoring the first AI/ML model,
a control for monitoring the first AI/ML model,
a periodicity for monitoring the first AI/ML model,
a duty cycle for monitoring the first AI/ML model,
a time duration for monitoring the first AI/ML model,
a time offset configuration for monitoring the first AI/ML model, or
a capability for the model monitoring method.

12. The method of any of claims 9-11, wherein if a plurality of first AI/ML models are monitored, the fourth information further indicates identities \of first AI/ML models in the plurality of first AI/ML models.

13. The method of claim 12, wherein the first configuration is configured for each first AI/ML model in the plurality of first AI/ML models, or
wherein the second configuration is configured for each first AI/ML model in the plurality of first AI/ML models.

14. The method of any of claims 1-13, further comprising:
receiving, from a third entity, the second information indicating the status of the second AI/ML model.

15. The method of any of claims 1-14, further comprising:
transmitting, to a fourth entity, a request for at least one of: the first decision or the first action performed by the fourth entity.

16. The method of any of claims 1-15, wherein the first action is associated with at least one of:
a latency requirement for the AI/ML management,
an overhead requirement for the AI/ML management,
a storage requirement for the AI/ML management,
a complexity requirement for the AI/ML management, or
a power consumption requirement for the AI/ML management.

17. The method of any of claims 1-16, wherein if a plurality of first AI/ML models are failed, the method further comprises at least one of:
obtaining a plurality of first information related to causes of failures of the plurality of first AI/ML models;
obtaining a plurality of second information related to statuses of the plurality of second AI/ML models; and
determining at least one of: a plurality of first decisions and a plurality of first actions based on the plurality of first information and the plurality of second information.

18. The method of any of claims 1-17, wherein the first entity is implemented at a terminal device, or
wherein the first entity is implemented at a network device.

19. A communication method, comprising:
determining, at a second entity, a model monitoring method for a first AI/ML model;
monitoring the first AI/ML model based on the model monitoring method; and
in accordance with a determination of a failure of the first AI/ML model, transmitting one of the followings to a first entity:
first information related to a cause of the failure of the first AI/ML model, or
fourth information about a model monitoring method for the first AI/ML model.

20. A communication device comprising:
at least one processor; and
at least one memory coupled to the at least one processor and storing instructions thereon, the instructions, when executed by the at least one processor, causing the communication device to perform the method according to any of claims 1-18 or claim 19.
